(19) United States
(12) Patent Application Publication
(10) Pub. No.: US 2020/0263710 A1
(43) Pub. Date: Aug. 20, 2020

(54) BENT SENSOR FOR POSITION TRANSDUCER

(71) Applicant: MTS SENSOR TECHNOLOGIE GMBH&CO.KG, Ludenscheid (DE)

(72) Inventors: Thomas Grahl, Neumarkt (DE); Ingo Walter, Siegen (DE)

(21) Appl. No.: 16/651,525

(22) PCT Filed: Sep. 28, 2018
(86) PCT No.: PCT/IB2018/057576

§ 371 Date: Mar. 27, 2020

Related U.S. Application Data
(60) Provisional application No. 62/564,859, filed on Sep. 28, 2017.

(51) Int. Cl. F15B 15/28; G01D 11/30; G01D 5/48

(52) U.S. Cl. CPC F15B 15/2861; G01D 5/485; G01D 11/30; F15B 15/2892

(57) ABSTRACT

A sensor assembly includes a body having a guide surface. A sensor head is mounted to the body. An elongated sensing element has a first end connected to the sensor head and a second end extending away from the first end along the body along a path of measurement. A first portion of the elongated sensing element extends from a sensor head bends by the guide surface so as to align a second portion of the sensing element with the path of measurement. A member is positionable along the path of measurement adjacent the second portion of the sensing element.

### CROSS-REFERENCE TO RELATED APPLICATION

The present application is a national stage of International patent application Serial No. PCT/IB2018/057576, filed Sep. 28, 2018, and published in English as WO 2019/064269.

### BACKGROUND

The discussion below is merely provided for general background information and is not intended to be used as an aid in determining the scope of the claimed subject matter.

Magnetostrictive sensors are state of the art and used in many applications as linear transducers. They are robust and can be produced to measure both very long length, e.g. 10 meter, but also short length such as 100 mm.

The sensors of known design have the drawback that the sensing element and the necessary electronics need to be held in a housing attached to the sensor rod. Due to space requirements this housing, also called a sensor head, requires a certain size. In the application of actuators, the size requirements result in a certain size diameter and or length of the housing. This limits the potential application of the sensors to a minimal size cylinder as the required outer diameter of the cylinder may not become smaller than the housing diameter of the sensor.

To overcome this technical problem sensors of known designs use a relatively smaller sensor head and a detached electronic circuitry. While this addresses the size constraints as mentioned above, it is cumbersome to install and offers more potential failures during installation.

Another problem of magnetostrictive sensors lies in the “null-zone”, which is the which is the distance between the sensor head where the sensing element resides, and the position on the sensor rod, where the sensor can start operating within its geometrical limits along the center line of the sensor rod.

### SUMMARY

This Summary and the Abstract herein are provided to introduce a selection of concepts in a simplified form that are further described below in the Detailed Description. This Summary and the Abstract are not intended to identify key features or essential features of the claimed subject matter, nor are they in-tended to be used as an aid in determining the scope of the claimed subject matter. The claimed subject matter is not limited to implementations that solve any or all disadvantages noted in the Background.

An aspect of the invention is a sensor assembly that includes a body having a guide surface. A sensor head is mounted to the body. An elongated sensing element has a first end connected to the sensor head and a second end extending away from the first end along a path of measurement on the body. A first portion of the elongated sensing element extends from the sensor head and is bent or curved by the guide surface so as to align a second portion of the sensing element with the path of measurement. A member is positionable along the path of measurement adjacent the second portion of the sensing element and is operable with the sensing element so that its position can be ascertained.

In one embodiment, the sensing element comprises a magnetostrictive waveguide and the member comprises a magnet; however aspects of the invention can be incorporated into other sensing technologies that use elongated sensing elements such as but not limited to hall effect devices.

Aspects of the invention are particularly advantageous for sensing a position of an element in a sealed chamber such as but not limited to an actuator having a cylinder forming a chamber and a piston movable in the chamber. In this type of environment, the second portion is positioned in the chamber, while the sensor head is mounted to the body exterior of the chamber such as on an exterior surface of the actuator. In such an application, the first portion is disposed in a portion of the actuator, such as the end cap of the actuator, so that the sensing element extends out of the chamber to the sensor head. If desired, the second portion of the sensing element can extend into a bore of a sensor rod that supports the second portion such as when disposed in a cylinder chamber. In addition, the first portion can extend through a conical inlet of the sensor rod that tapers inwardly to the bore so as to aid in positioning the sensing element in the bore.

The sensing element is bent or curved such as into a constant or varying radius that still allows the sensor to provide proper signal strength. The guide surface can be incorporated into a portion of the body so as to be integral therewith being formed as a single unitary body. Alternatively, the guide surface can be formed in a component such as an insert which can be removably mounted to the body. The guide surface bends the first portion of the sensing element, allowing the second portion to extend along the length of the body such as in the chamber of a cylinder body and/or with the piston rod of a hydraulic or pneumatic actuator. It should be noted however that aspects of the invention are not limited to actuators, but rather can be implemented on any other apparatus or body where the sensor should measure the distance along any virtual line of the body such as being at an angle with, parallel with, or collinear with a centerline of the body. In addition, the sensor head can be mounted to the body and oriented with respect to the centerline at any desired angle so the sensor head can be positioned into an area with less space constraints.

Another aspect of the invention is a method for installing or mounting a sensor having a sensor head and elongated sensing element to a body, the body having a guide surface for the sensing element and the sensing element having a first end and a second end. The method includes connecting the sensor head to the first end of the sensing element and engaging the second end of the sensing element with and displacing the sensing element along the guide surface so as to bend the sensing element such the sensing element extends along the path of measurement. If desired, the sensor head can be connected to the first end of the sensing element after the sensing element has been positioned on the body. The sensor head is mounted to the body such that a first portion of the sensing element extends from the sensor head along the guide surface and a second portion extends along the path of measurement. The second portion is disposed adjacent the member that is positionable with respect to the body. Any of the afore-mentioned features discussed above with respect to the first aspect can be included if desired.

### BRIEF DESCRIPTION OF THE DRAWINGS

FIG. 1 is a schematic pictorial view of a magnetostrictive sensor.

FIG. 2 is a schematic sectional view of a prior art magnetostrictive sensor in an actuator such as a hydraulic cylinder.

FIG. 3 is a partial perspective view the prior art magnetostrictive sensor in the hydraulic cylinder.

FIG. 4 is a schematic sectional view of an exemplary embodiment of the invention in a cylinder.

FIG. 5 is a perspective view of a guide insert.

FIG. 6 is another sectional view of the exemplary embodiment of FIG. 4.

FIG. 7 is schematic view of installation of the exemplary embodiment of FIG. 4.

FIG. 8 is a partial perspective view of the exemplary embodiment of FIG. 4.

FIG. 9 is a sectional view of a guide body of a second exemplary embodiment.

### DETAILED DESCRIPTION

In an exemplary embodiment, the sensor can employ magnetostriction.

Magnetostriction is a property of ferromagnetic materials to undergo a change of their physical dimensions when subjected to a magnetic field.

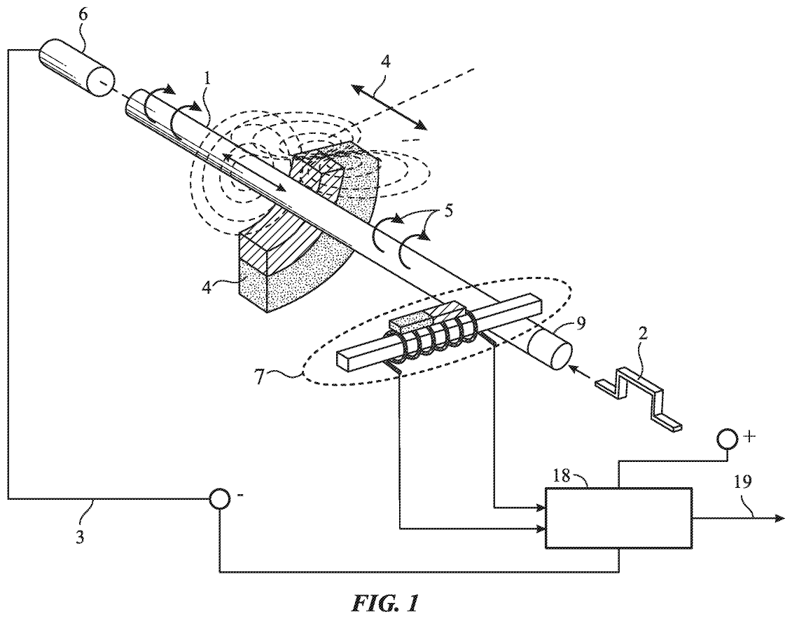

Referring to FIG. 1, in a wire with magnetoelastics properties, called a waveguide waveguide 1, an electric current pulse 2 is induced by a controller 18 having an electric pulse generator commonly used in magnetostrictive sensors, and thus not further elaborated herein. When the pulse 2 is sent, a clock of the controller 18 is started. The pulse 2 is transferred through the magnetoelastic material and the electric circuit is closed by means of a return wire 3 connected to the end of the waveguide 1. Through the electric pulse 2, which basically happens instantaneously as the electrons move with the speed of light, a magnetic field is generated in the waveguide 1. When this field interacts with a position magnet 4 an acoustic ultrasonic wave 5 is generated in the waveguide 1. This acoustic wave 5 travels from both sides of the magnet 4 into the waveguide 1. In particular, the acoustic wave 5 along the left hand side of the waveguide 1 in FIG. 1 to a damper 6 and along the right hand side into an ultrasonic wave converter 7. When the acoustic wave 5 reaches the wave converter 7, an electrical signal is generated through an inductive coil 8 in the wave converter 7. This signal is provided to the controller 18 that triggers the above mentioned clock to stop. As the speed at which the ultrasonic wave 5 moves through the waveguide 1 is known, one can determine the geometrical distance of the position magnet 4 to the ultrasonic wave converter 7 from the clocked time, often called “time of flight”. The “time of flight” is used by the controller 18 to provide a suitable output signal 19 indicative of the position of the magnet 4. Such processing is well known in magnetostrictive sensors.

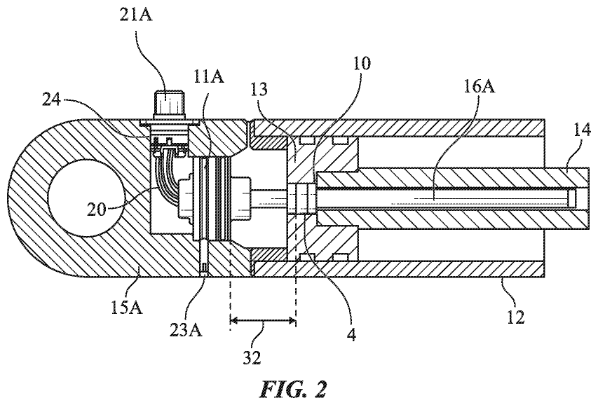

FIG. 2 illustrates, as a typical example, the current manner of installation of a magnetostrictive linear transducer or sensor 17 in a hydraulic actuator having a piston 13 movable in a cylinder 12. The magnetostrictive sensor 17 includes a sensor head 11A that is mounted firmly to a cylinder body 15A. The sensor head 11A houses the ultrasonic wave converter 7, which is connected to the waveguide 1, residing adequately protected in a sensor rod 16A. The sensor head 11A and the sensor rod 16A are firmly connected, e.g. welded or brazed, with each other. The Position Magnet 4 is mounted into a non-ferromagnetic mounting Bushing 10 which resides firmly in the Piston 13 of the cylinder 12. The Piston rod 14 is hollow to the left hand side of the piston 13. The sensor rod 16A fits into a hollow cavity provided in the sensor rod 16A. When the piston 13 moves relative to the cylinder body 15A, the connected mounting bushing 10 and position magnet 4 move with the piston 13 over the length of the sensor rod 16A. The magnetostrictive sensor operates in the manner described above and uses the magnetostrictive-effect described above to provide an output indicative of the measured distance or position of the magnet 4.

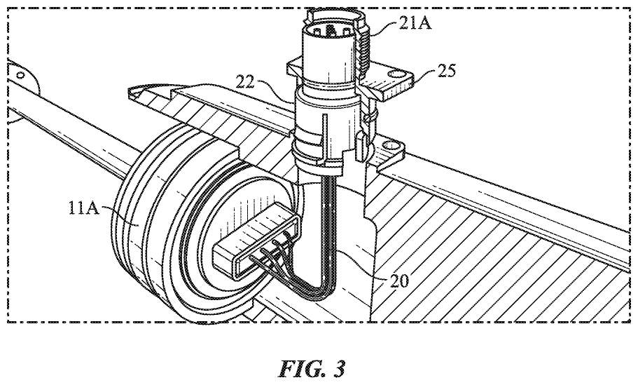

FIG. 3 shows how the output signal of the sensor is physically transferred from the from the exemplary cylinder to a suitable measuring system of the application into which the cylinder is installed. The Output Signal 19 of the controller 18 is electronically transferred by means of cable wiring 20 to a connector having a connector insert 22 located in a connector housing. When the sensor 17 is mounted into the cylinder 12, it is moved from the right hand side in FIG. 2 into the cylinder body 15. The sensor head 11A is then fixed by a set screw 23A. At the same time when the sensor head 11A is moved into the cylinder body 15, the cable wiring 20 with the connector insert 22 is thread through the corresponding a connector opening 24 in the cylinder body 15A. When the connector insert 22 comes out from the cylinder body 15A through the corresponding connector opening 24 during the assembly, the connector housing 21A is firmly clipped onto the connector insert 22 and finally the connector housing is screwed with its connector flange 25 onto the cylinder body 15A.

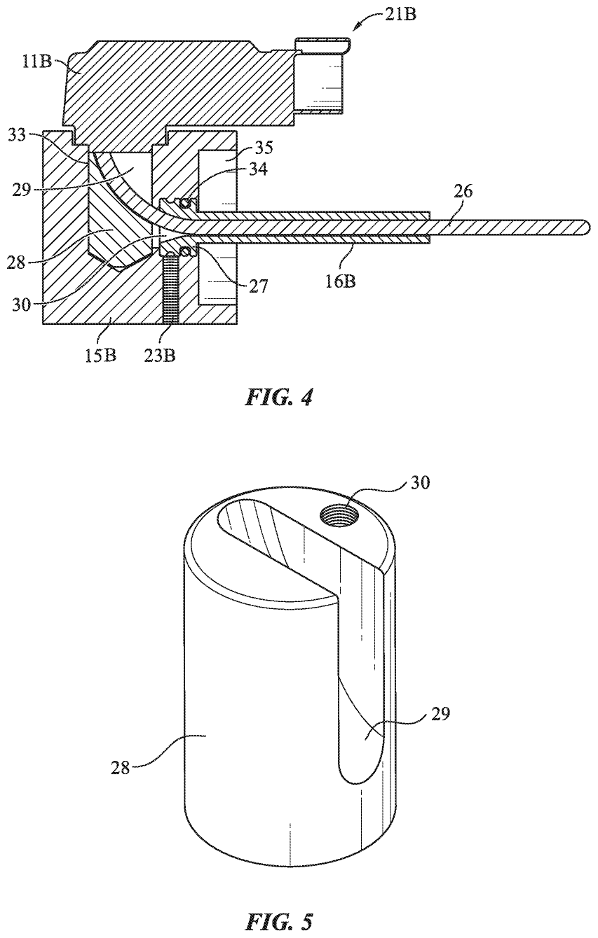

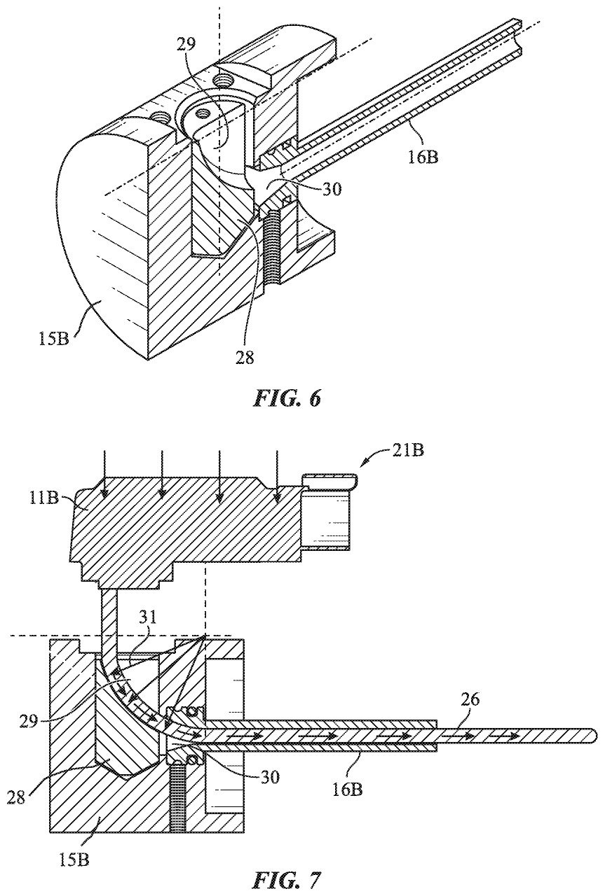

FIG. 4 shows aspects of an improved sensor assembly. Generally, the sensor assembly includes a body having a guide surface. A sensor head is mounted to the body. An elongated sensing element has a first end connected to the sensor head and a second end extending away from the first end along a path of measurement on the body. A first portion of the elongated sensing element extends from the sensor head and is bent or curved by the guide surface so as to align a second portion of the sensing element with the path of measurement. A member is positionable along the path of measurement adjacent the second portion of the sensing element and is operable with the sensing element so that its position can be ascertained. By way of example, a magnetostrictive sensor is again used where the body comprises an actuator. However in FIG. 4 the piston and cylinder body of the actuator are not shown but could be similar to that illustrated in FIG. 2.

In this new design the former sensor head 11 is replaced by a sensor head 11B, which is mounted to the body such as to the outside of a cylinder chamber 35 formed by inner walls of the cylinder body 15B and the cylinder, not shown, but connected to the cylinder body 15B. The sensor head 11B houses the ultrasonic wave converter 7, which is connected to the waveguide 1, wherein the waveguide 1 can reside in a protection tube 26. The protection tube 26 can be made from any suitable material such as metal, but in an advantageous embodiment is a flexible material such as plastic. In a preferred embodiment, the sensor rod 16B is separated from the sensor head 11 If desired, the design allows to have the former connector housing 21 as an integral connector housing 21B part of the sensor head 11B; however the construction is not limited to such solution and could also be designed with a cable outlet.

As a consequence of the new design, mounting or installation of the magnetostrictive sensor into the cylinder is different. In one embodiment, at first the sensor rod 16B is moved into the cylinder body 15B from the right hand side. The sensor rod 16B is firmly held in the cylinder body 15B at its sensor rod flange 27, for example, by means of a set screw 23B, although other mounting mechanisms can be used such as cooperating mechanical connections such as threads provided on the sensor rod flange and corresponding threads on the cylinder body 18. If desired, adhesive with or without the cooperating mechanical connections can be used. In the illustrated embodiment, the sensor rod flange 27 can hold a sealing ring 34, which seals the cylinder chamber 35 against a filling opening 33 to prevent the media used for actuator operation, for example hydraulic oil, from ingression into the filling opening 33. In one embodiment, as the next step, a filling insert 28, which has a curved slot 29 that forms the guide surface is placed into the filling opening 33 of the cylinder body 15, which could be machined into the cylinder body 15 by means of a drill having the same or slightly larger diameter than the filling insert 28. In one embodiment, a center axis 28A of the filling insert 28 and the corresponding filling opening 33 is typically perpendicular to an axis of sensor rod 16B, although this is not a requirement.

FIG. 5 shows the filling insert 28 and the curved slot 29. The width of the curved slot 29 is equal or slightly larger than the protection tube 26, but is of size to hold the waveguide 1. If desired, the filling insert 28 can include a projection or recess, allowing the filling insert 28 to be removed from the filling opening 33. In the illustrated embodiment, threads 30 are provided in a recess to mate with threads provided on a puller that mate with threads 30.

The waveguide 1 extends through the filling insert 28 the sensor rod flange 27 and the sensor rod 16B such that the curved guide surface 29 is aligned with the bore provided in the sensor rod flange 27. In one embodiment, the filling insert 28 can be aligned the sensor rod 16b in the following way. The alignment of the filling insert 28 could be adjusted by simple sliding a screwdriver of adequate size into the groove of the curve slot while turning the filling insert 28 around a center axis 28A. The length and diameter of the filling insert 28 should be varied with especially the diameter of the cylinder. In another embodiment, mating surfaces on cooperating elements between the filling insert 28 and the cylinder body 15B can be provided and used to control the orientation of the filling insert 28 as it is inserted into the cylinder body 15B

When the curved guide surface 29 is properly aligned, the waveguide 1 of the the magnetostrictive sensor is pushed with its protection tube 26 so as to engage the curved guide surface 29 of the filling insert 28, which can be perpendicular to the center line of the sensor rod 16b. The curved guide surface 29 guides the waveguide 1 and protection tube 26 into the sensor flange 27A, which being aligned with the sensor rod 16B allows the waveguide 1 and protection tube 26 to be pushed into the sensor rod 16B. If desired, an opening or inlet 31 of the bore of the sensor rod flange 27 facing the filling insert 28 can be larger than the opening of the curved guide surface 29, for example conically shaped, so as to help guide the waveguide 1 and protection tube 26 into the sensor rod flange 27. At this point it can be noted that in the embodiment illustrated, the sensor rod 16b is commonly aligned with the center axis of the cylinder; however, this is not a requirement. Likewise, although illustrated where the waveguide 1 and protection tube are inserted into the body with a generally perpendicular or near perpendicular motion, this is not a requirement in that depending on an opening associated with the guide surface 29 insertion may be of a different orientation.

The curved guide surface 29 of the filling insert 28 together with, in one embodiment, the conical, or almost conical shaped, conical inlet 30 of the sensor rod 16b forms a guiding template into which the flexible protection tube 26 can slide with a bending radius 31. After passing this radius the flexible protection tube 26 relaxes and, during the installation into the sensor rod 16B, slides along the sensor rod 16b. If desired, grease or other suitable lubricant can be used so as to aid sliding of the protection tube 26 in the above-mentioned parts. It should be noted A null zone 32 of the magnetostrictive sensor now lies in the area of the bending radius 31 making the sensor installation more compact as the null zone 32 does not need to be considered along the length of the collinear part of the sensor and the cylinder.

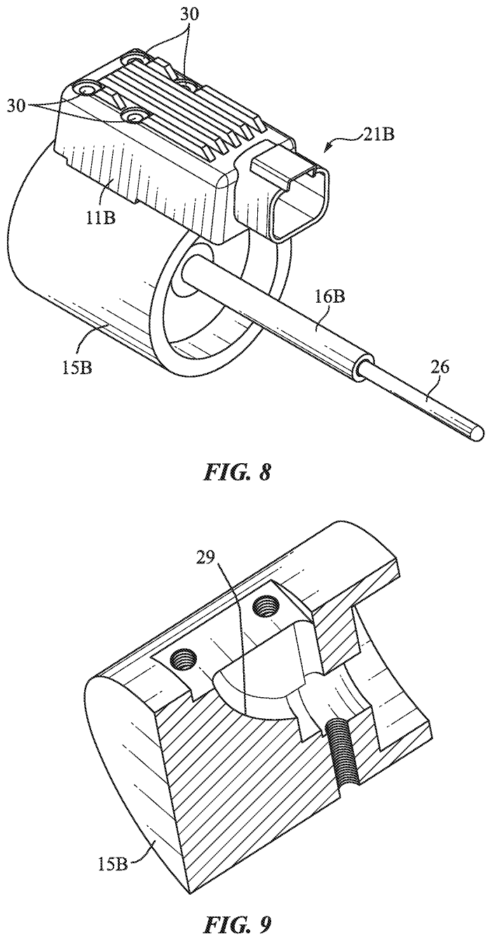

When the sensor head 11B is finally placed onto the outer rim of the cylinder as shown in FIG. 8, it can be secured in place by fasteners herein exemplified by mounting screws 30, here four screws are shown as an example. If the bolt pattern is symmetrical, the orientation of the sensor head 11B could be modified by turning the sensor head 11B on the bolt pattern. The connection between the sensor head 11B and the cylinder body 15B should preferably be done by means of a centering diameter and proper sealing. It should be appreciated that the important advantage of the improved sensor design allows the sensing element, herein the waveguide 1, to be installed and/or serviced without opening the chamber 35.

FIG. 9 illustrates another embodiment where the curved guide surface 29 is formed integral with the cylinder body 15B from a single unitary body.

Although the subject matter has been described in language directed to specific specific environments, structural features and/or methodological acts, it is to be understood that the subject matter defined in the appended claims is not limited to the environments, specific features or acts described above as has been held by the courts. Rather, the environments, specific features and acts described above are disclosed as example forms of implementing the claims.

1. A sensor assembly, comprising:
a body having a guide surface;
a sensor head mounted to the body;
an elongated sensing element having a first end connected to the sensor head and a second end extending away from the first end along the body along a path of measurement, wherein a first portion of the elongated sensing element extending from sensor head bends by the guide surface so as to align a second portion of the sensing element with the path of measurement; and
a member positionable along the path of measurement adjacent the second portion of the sensing element.

2. The sensor assembly of claim 1 wherein the sensing element comprises a waveguide and the member comprises a magnet.

3. The sensor assembly of claim 2 wherein the body comprises an actuator having a cylinder forming a chamber and a piston movable in the chamber, and wherein the second portion is positioned in the chamber, wherein the sensor head is mounted to the body exterior of the chamber and the first portion is disposed in a portion of the actuator so that the sensing element extends out of the chamber to the sensor head.

4. The sensor assembly of claim 3 wherein the sensor head is mounted to an exterior surface of the actuator wherein the guide surface comprises a passageway having an opening in the exterior surface.

5. The sensor assembly claim 1 wherein the first portion is curved.

6. The sensor assembly of claim 5 wherein the first portion is curved with a constant radius.

7. The sensor assembly of claim 5 wherein the first portion is curved with a varying radius.

8. The sensor assembly of claim 3 wherein the first portion and the guide surface and are disposed in an end cap of the actuator.

9. The sensor assembly of claim 8 wherein the guide surface is formed in a guide member removably attached to the end cap.

10. The sensor assembly of claim 8 wherein the guide surface is formed integral with the end cap from a single unitary body.

11. The sensor assembly of claim 8 and a sensor rod having an end mounted to the end cap and extending in the chamber, wherein the sensor rod includes a bore, and wherein the second portion is disposed in the bore.

12. The sensor assembly of claim 11 wherein the sensor rod includes a sensor flange configured to mount the sensor rod in the chamber, the bore extending through the sensor flange.

13. The sensor assembly of claim 12 wherein the first portion extends through a conical inlet tapering inwardly to the bore.

14. The sensor assembly of claim 3 wherein the path of measurement is on a central axis of the chamber.

15. The sensor assembly of claim 3 wherein the magnet is mounted to the piston.

16. A method for installing a sensor having a sensor head and elongated sensing element to a body, the body having a guide surface for the sensing element and the sensing element having a first end and a second end, the method comprising:
connecting the sensor head to a first end of the sensing element;
engaging the second end of the sensing element and displacing the sensing element along the guide surface bends the sensing element such the sensing element extends along a path of measurement; and
mounting the sensor head to the body such that a first portion of the sensing element extends from the sensor head along the guide surface and a second portion extends along the path of measurement where the second portion is disposed adjacent a member that is positionable with respect to the body.

17. The method of claim 16 wherein the sensing element comprises a waveguide and the member comprises a magnet.

18. The method of any claim 16 wherein the body comprises an actuator having a cylinder forming a chamber and a piston movable in the chamber, and wherein displacing the sensing element includes inserting the second portion in the chamber, and wherein mounting the sensor head to the body comprises mounting the sensor head to an exterior surface of the body and wherein the first portion is disposed in a portion of the actuator so that the sensing element extends out of the chamber to the sensor head.

19. The method of claim 18 wherein the guide surface comprises a passageway having an opening in the exterior surface, and wherein displacing the sensing element comprises inserting the sensing element into the opening.

20. The method of claim 16 wherein displacing the sensing element causes the first portion to be curved.

21. (canceled)

22. (canceled)

23. The method of claim 20 wherein the guide surface is formed in a guide member and the guide member is inserted into the body.

24. (canceled)

25. (canceled)

26. (canceled)
